(19) United States
(12) Patent Application Publication
(10) Pub. No.: US 2026/0101307 A1
(43) Pub. Date: Apr. 9, 2026

(54) TERMINAL POSITIONING METHOD AND APPARATUS

(71) Applicant: Beijing Xiaomi Mobile Software Co., Ltd., Beijing (CN)

(72) Inventor: Yajun ZHU, Beijing (CN)

(21) Appl. No.: 19/113,214

(22) PCT Filed: Sep. 21, 2022
(86) PCT No.: PCT/CN2022/120358

§ 371 Date: Mar. 19, 2025

(51) Int. Cl. H04W 64/00; H04L 5/00; H04L 43/0864

(52) U.S. Cl. CPC H04W 64/00; H04L 5/0048; H04L 43/0864

(57) ABSTRACT

A terminal positioning method is performed by a base station, includes: determining a first latency variation of a feeder link corresponding to a terminal; receiving a second latency variation of a service link reported by the terminal; determining a round-trip latency from the base station to the terminal according to the first latency variation and the second latency variation, and determining a location of the terminal based on the round-trip latency.

### CROSS-REFERENCE TO RELATED APPLICATION

This application is the U.S. national phase application of International Application No. PCT/CN2022/120358, filed on Sep. 21, 2022, the disclosure of which is incorporated herein by reference in its entirety.

### TECHNICAL FIELD

The present disclosure relates to the field of wireless communication technologies, and in particular, to a terminal positioning method and apparatus.

### BACKGROUND

In the study of wireless communication technologies, satellite communications are considered an important aspect of the future development of wireless communication technologies. The satellite communication refers to a communication with a ground radio communication device using a satellite as relay. A satellite communication system consists of a satellite part and a ground part. The characteristics of the satellite communications are: large communication range; being possible between any two points within a coverage of radio waves emitted by satellites; less susceptible to disasters on land (high reliability). The satellite communications act as a complement to current terrestrial cellular communication systems. It is foreseeable that in future wireless communication systems, the satellite communication systems and the terrestrial cellular communication systems will gradually achieve deep integration to realize the actual internet of everything.

In the satellite communication system, a long propagation distance causes a large deviation between uplink and downlink timing. A terminal has to maintain uplink synchronization based on global navigation satellite system (GNSS) measurements and some auxiliary information. In a satellite communication scenario, a data transmission takes long time due to the long signal transmission distance between a transmitter and a receiver. For related uplink and downlink transmissions, a latency parameter is determined to be introduced in the current standardization discussion to compensate for a transmission latency. To determine the time parameter, the terminal is expected to report its location information. The terminal may obtain its own location information based on its own GNSS measurement and report it to a network side. However, for the network side, it is prone to insufficiently accurate positioning for the terminal due to some unreliable factors of the location information obtained by the terminal based on the GNSS (for example, the location information reported by the terminal is false, the GNSS information of the terminal is manipulated, etc.).

In current methods, the reliability of the location information reported by the terminal may be verified by means of providing location information at the network side. In a current method, the location information of the terminal may be obtained using multi-round trip time (multi-RTT). However, in a case where the positioning is achieved by a single satellite, the rapid movement of the satellite causes a large positioning error, so that the positioning error of the terminal cannot be reduced and the location information of the terminal cannot be obtained accurately.

### SUMMARY

The present disclosure provides a terminal positioning method and apparatus, which can reduce a positioning error of a terminal and accurately obtain location information of the terminal.

An example in a first aspect of the present disclosure provides a terminal positioning method, which is performed by a base station and includes:
determining a first latency variation of a feeder link corresponding to a terminal;
receiving a second latency variation of a service link reported by the terminal;
determining a round-trip latency from the base station to the terminal according to the first latency variation and the second latency variation, and
determining a location of the terminal based on the round-trip latency.

An example in a second aspect of the present disclosure provides a terminal positioning method, which is performed by a terminal and includes:

reporting a second latency variation of a service link to a base station, wherein the second latency variation is configured for determining a round-trip latency from the base station to the terminal.

An example in a third aspect of the present disclosure provides a communication device, which includes: one or more transceivers; one or more memories; and one or more processors connected to the one or more transceivers and the one or more memories separately, wherein the one or more processors are configured to: determine a first latency variation of a feeder link corresponding to a terminal; receive a second latency variation of a service link reported by the terminal; determine a round-trip latency from the base station to the terminal according to the first latency variation and the second latency variation, and determine a location of the terminal based on the round-trip latency.

For additional aspects and advantages of the present disclosure, a part of them will be set forth in the following description, and another part of them will be apparent according to the following description or be learned through putting the present disclosure into practice.

### BRIEF DESCRIPTION OF THE DRAWINGS

The above and/or additional aspects and advantages of the present disclosure will become apparent and readily understood according to the following description of the examples in conjunction with the accompanying drawings.

FIG. 1 is a schematic flowchart of a terminal positioning method according to an example of the present disclosure.

FIG. 2 is a schematic flowchart of a terminal positioning method according to an example of the present disclosure.

FIG. 3 is a schematic flowchart of a terminal positioning method according to an example of the present disclosure.

FIG. 4 is a schematic flowchart of a terminal positioning method according to an example of the present disclosure.

FIG. 5 is a schematic flowchart of a terminal positioning method according to an example of the present disclosure.

FIG. 6 is a schematic flowchart of a terminal positioning method according to an example of the present disclosure.

FIG. 7 is a time series diagram of a terminal positioning method according to an example of the present disclosure.

FIG. 8 is a block diagram of a terminal positioning apparatus according to an example of the present disclosure.

FIG. 9 is a block diagram of a terminal positioning apparatus according to an example of the present disclosure.

FIG. 10 is a schematic structural diagram of a communication device according to an example of the present disclosure.

FIG. 11 is a schematic structural diagram of a chip provided in an example of the present disclosure.

### DETAILED DESCRIPTION OF THE EMBODIMENTS

Examples of the present disclosure are described in detail below, whose illustrations are shown in the accompanying drawings. The same or similar reference numerals throughout represent the same or similar elements or elements having the same or similar functions. The examples, which are described below with reference to the accompanying drawings, are illustrated and are intended to explain the present disclosure, but should not be construed as a limitation of the present disclosure.

In a satellite communication system, a data transmission takes long time due to the long signal transmission distance between a transmitter and a receiver. For related uplink and downlink transmissions, a latency parameter is determined to be introduced in the current standardization discussion to compensate for a transmission latency. To determine the latency parameter, a terminal is expected to report its location information. The terminal may obtain its own location information based on its own global navigation satellite system (GNSS) measurement and report it to a network side. However, for the network side, it is prone to insufficiently accurate positioning for the terminal due to some unreliable factors of the location information obtained by the terminal based on the GNSS (for example, the location information reported by the terminal is false, the GNSS information of the terminal is manipulated, etc.). Under the current mechanism, the reliability of the location information reported by the terminal may be verified by means of providing location information at the network side. For example, the location information of the terminal may be obtained using a multi-round trip time (multi-RTT). However, in a case where the positioning is achieved by a single satellite, the rapid movement of the satellite causes a large positioning error, so that the positioning error of the terminal cannot be reduced and the location information of the terminal cannot be obtained accurately.

Therefore, the present disclosure provides a terminal positioning method and apparatus, which can reduce the positioning error of the terminal and accurately obtain the location information of the terminal.

The terminal positioning methods and apparatuses can calculate the latency variations on the feeder link and the service link when a satellite moves rapidly, determine the round-trip latency from the base station to the terminal according to the latency variation, and achieve accurately positioning the terminal based on the round-trip latency, thereby reducing the terminal positioning error caused by the rapid satellite movement.

The terminal positioning methods and apparatuses provided in the present disclosure are described in detail below in conjunction with the accompanying drawings.

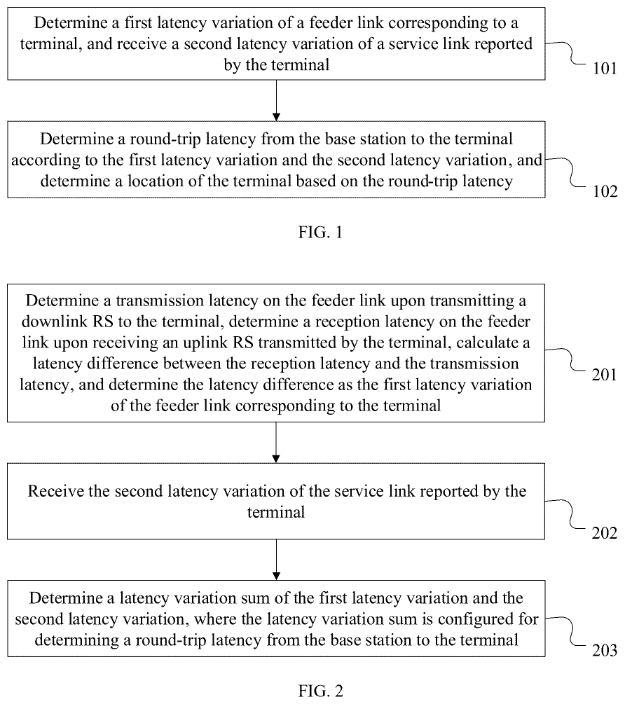

FIG. 1 illustrates a schematic flowchart of a terminal positioning method according to an example of the present disclosure. As illustrated in FIG. 1, the method is to be performed by a base station and may include the following steps.

At step 101, a first latency variation of a feeder link corresponding to a terminal is determined, and a second latency variation of a service link reported by the terminal is received.

The terminal is user equipment (UE) to be positioned, the feeder link is a communication link between a satellite and the ground base station, and the service link is a communication link between the satellite and the terminal.

In the example of the present disclosure, when determining the latency variation of the terminal caused by satellite movement, the base station may be used to determine the first latency variation of the feeder link corresponding to the terminal, the terminal may be used to determine the second latency variation of the service link, and the terminal may report the second latency variation to the base station, so that the base station may position the terminal based on the first latency variation of the feeder link and the second latency variation of the service link.

At step 102, a round-trip latency from the base station to the terminal is determined according to the first latency variation and the second latency variation, and a location of the terminal is determined based on the round-trip latency.

In the example, after determining the first latency variation of the feeder link and the second latency variation of the service link, a latency sum of the first latency variation and the second latency variation may be determined as a total latency variation caused by the satellite movement. Then, by adding the total latency variation to an overall latency calculated in a traditional way, the actual round-trip time (RTT) from the base station to the terminal under the influence of satellite movement may be determined. During determining the location of the terminal, the above steps may be repeated multiple times to calculate multiple (at least 3) final RTTs, and the terminal may be positioned on multiple circles with the base station as the centre and c*RTTs (where c is the speed of light) as the radii. The intersection point of the multiple circles is the actual location of the terminal.

According to the terminal positioning method provided in the example of the present disclosure, the latency variations on the feeder link and the service link may be calculated when the satellite moves rapidly, the round-trip latency from the base station to the terminal may be determined according to the latency variations, and it is achieved that the terminal is accurately positioned based on the round-trip latency, thereby reducing the terminal positioning error caused by the rapid satellite movement.

FIG. 2 illustrates a schematic flowchart of a terminal positioning method according to an example of the present disclosure. The method, which is based on the example illustrated in FIG. 1 and is illustrated in FIG. 2, is performed by a base station and may include the following steps.

At step 201, a transmission latency on the feeder link is determined upon transmitting a downlink reference signal (RS) to the terminal, a reception latency on the feeder link is determined upon receiving an uplink RS transmitted by the terminal, a latency difference between the reception latency and the transmission latency is determined, and the latency difference is determined as the first latency variation of the feeder link corresponding to the terminal.

For example, at a time point when the base station transmits the downlink RS such as a positioning reference signal (PRS) to the terminal, the base station determines that the transmission latency of the feeder link is D1; and at a time point when the base station receives the uplink RS transmitted by the terminal such as a channel sounding reference signal (SRS), the base station determines that the reception latency of the feeder link is D2. Furthermore, the base station further determines that the first latency variation of the feeder link is D2−D1 according to the reception latency and the transmission latency.

At step 202, the second latency variation of the service link reported by the terminal is received.

In a specific application scenario, before the second latency variation of the service link reported by the terminal is received, a first configuration information may further be sent to the terminal. The first configuration information includes a plurality of preset transmission times for transmitting the uplink RS, so that the terminal selects a signal transmission time of the uplink RS from the plurality of preset transmission times based on the first configuration information, and determines a time interval between receiving the downlink RS and transmitting the uplink RS according to the signal transmission time and a signal reception time of the downlink RS. The first configuration information may be a high-level signaling or a physical layer signaling. In addition, the base station may further send satellite indication information to the terminal, so that the terminal determines the second latency variation of the service link according to the satellite indication information and the time interval between receiving the downlink RS and transmitting the uplink RS. The satellite indication information includes second configuration information of a target satellite. The second configuration information includes information for determining a motion trajectory and a motion velocity of the target satellite.

Correspondingly, before the second latency variation of the service link reported by the terminal is received, a first indication signaling may further be sent to the terminal, where the first indication signaling indicates an uplink resource for transmitting the uplink RS, so that the terminal reports the second latency variation of the service link explicitly to the base station via an uplink channel indicated by the uplink resource. Alternatively, a second indication signaling may further be sent to the terminal, where the second indication signaling indicates a correspondence between uplink RS transmission information and second latency variations, so that the terminal determines a piece of uplink RS transmission information according to the correspondence between uplink RS transmission information and second latency variations, and reports the second latency variation of the service link implicitly to the base station on the basis of the piece of uplink RS transmission information. The second indication signaling is a high-layer signaling or a physical layer signaling. The uplink RS transmission information includes one item of the following: time domain resources occupied by an uplink RS transmission; frequency domain resources occupied by the uplink RS transmission; or RS sequences for the uplink RS transmission. The high-layer signaling may include system information, a radio resource control (RRC) signaling, or a media access control (MAC) control element (CE).

At step 203, a latency variation sum of the first latency variation and the second latency variation is determined, where the latency variation sum is configured for determining a round-trip latency from the base station to the terminal.

According to the terminal positioning method provided in the example of the present disclosure, when the satellite moves rapidly, it may use the base station to determine the first latency variation on the feeder link, use the terminal to determine the second latency variation on the service link, and finally use the base station to determine the actual round-trip latency from the base station to the terminal under the influence of satellite movement according to the first latency variation and the second latency variation. It achieves accurately positioning the terminal based on the round-trip latency, and reduces the terminal positioning error caused by the rapid satellite movement.

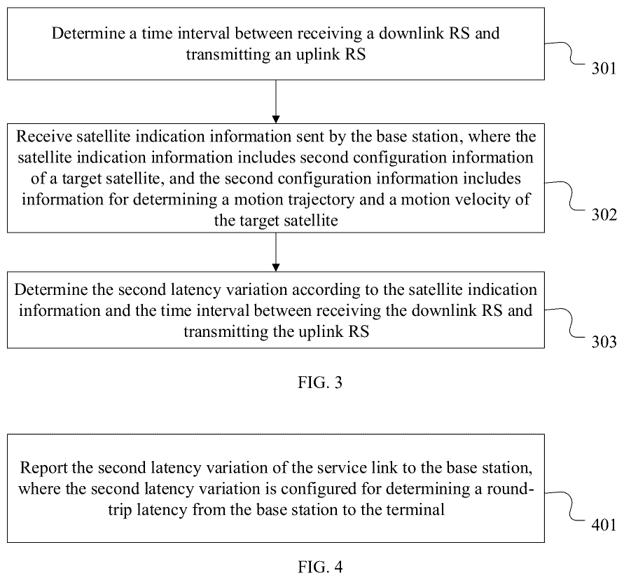

FIG. 3 is a schematic flowchart of a terminal positioning method according to an example of the present disclosure. The method is performed by a terminal and may include the following steps.

At step 301, a time interval between receiving a downlink RS and transmitting an uplink RS is determined.

In the example of the present disclosure, the time interval between receiving the downlink RS transmitting by a base station and transmitting the uplink RS may be determined by the terminal. In an implementation, the time interval may be determined autonomously by the terminal. Particularly, the terminal may predefine a fixed value as the time interval between receiving the downlink RS and transmitting the uplink RS. For example, the specific value of the time interval may be set based on the type of the RS, the data transmission capability of the terminal, etc., which is not specifically limited here. In an implementation, the time interval may be determined by the terminal according to the configuration information from the base station. Particularly, after receiving the downlink RS, the terminal may use a local clock to record a signal reception time of the downlink RS, select any time after the signal reception time from one or more preset transmission times pre-configured by the base station as a signal transmission time for transmitting the uplink RS to the base station, and further determine a time difference between the selected signal transmission time and the signal reception time as the time interval between receiving the downlink RS and transmitting the uplink RS.

Correspondingly, the step 301 in the example may specifically include: obtaining the predefined time interval between receiving the downlink RS and transmitting the uplink RS. Alternatively, the step 301 in the example may specifically include: determining the signal transmission time of the uplink RS among a plurality of preset transmission times based on the signal reception time of the downlink RS, and determining the time interval between receiving the downlink RS and transmitting the uplink RS according to the signal transmission time and the signal reception time. The plurality of preset transmission times are sent by the base station to the terminal. Accordingly, before performing the step in the example, it may further include: receiving first configuration information sent by the base station. The first configuration information includes the plurality of preset transmission times for transmitting the uplink RS, and the first configuration information may be a high-level signaling or a physical layer signaling.

At step 302, satellite indication information sent by the base station is received, where the satellite indication information includes second configuration information of a target satellite, and the second configuration information includes information for determining a motion trajectory and a motion velocity of the target satellite.

In a specific application scenario, after determining a satellite that plays a relay role in a communication with the terminal, the base station may further obtain the satellite indication information about the satellite and send the satellite indication information to the terminal. In the example of the present disclosure, after receiving the satellite indication information, the terminal may accurately determine the motion trajectory and the motion velocity of the target satellite according to the information that is carried by the second configuration information in the satellite indication information and is used for determining the motion trajectory and the motion velocity of the target satellite, so as to accurately calculate a second latency variation of the service link of the terminal under the influence of satellite motion based on the motion trajectory and the motion velocity of the target satellite, which facilitates accurately positioning the terminal.

At step 303, the second latency variation is determined according to the satellite indication information and the time interval between receiving the downlink RS and transmitting the uplink RS.

According to the terminal positioning method provided in the example of the present disclosure, when the satellite moves rapidly, the second latency variation of the service link may be calculated by integrating the time interval between receiving the downlink RS and transmitting the uplink RS with the information about the motion trajectory and the motion velocity of the satellite, etc. Therefore, the calculated latency information on the service link is associated with the satellite movement information, thereby ensuring the accuracy of the determined second latency variation of the service link, which facilitates accurately positioning the terminal and reduces the terminal positioning error caused by the rapid satellite movement.

FIG. 4 illustrates a schematic flowchart of a terminal positioning method according to an example of the present disclosure. The method, which is based on the example illustrated in FIG. 3 and is illustrated in FIG. 4, is performed by a terminal and may include the following step.

At step 401, the second latency variation of the service link is reported to the base station, where the second latency variation is configured for determining a round-trip latency from the base station to the terminal.

In the example of the present disclosure, after determining the second latency variation of the service link of the terminal based on steps 301 to 303 in the previous example, the second latency variation may be reported to the base station, so that the base station may determine the round-trip latency from the base station to the terminal according to the first latency variation of the feeder link and the second latency variation of the service link, and determine the location of the terminal based on the round-trip latency. When reporting the second latency variation of the service link to the base station, two schemes may be adopted, explicit reporting and implicit reporting, Correspondingly, in the example, the steps of the example may specifically include: reporting the second latency variation of the service link explicitly to the base station; or, reporting the second latency variation of the service link implicitly to the base station. Particularly, when the second latency variation is reported explicitly, reference may be made to the relevant descriptions of steps 501 to 502 in an example; and when the second latency variation is reported implicitly, reference may be made to the relevant descriptions of steps 601 to 602 in an example.

According to the terminal positioning method provided in the example of the present disclosure, it may selectively adopt an explicit or implicit reporting form when the terminal reports the second latency variation of the service link to the base station. By providing a variety of reporting types, the expression form of reporting the information can be enriched, which can better meet the actual communication requirements when reporting the second latency variation.

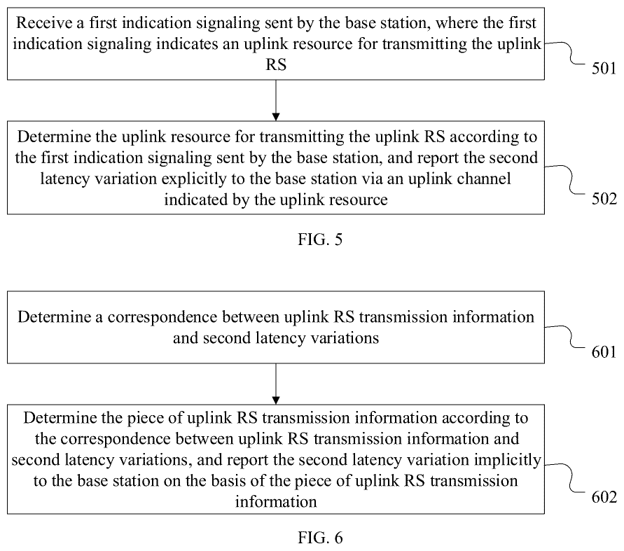

FIG. 5 illustrates a schematic flowchart of a terminal positioning method according to an example of the present disclosure. The method, which is based on the examples illustrated in FIG. 3 and FIG. 4 and is illustrated in FIG. 5, is performed by a terminal and may include the following steps.

At step 501, a first indication signaling sent by the base station is received, where the first indication signaling indicates an uplink resource for transmitting the uplink RS.

In the example of the present disclosure, when the terminal reports the second latency variation explicitly to the base station, the base station may send the first indication signaling to the terminal for indicating the uplink resource for transmitting the uplink RS, and the terminal may determine the uplink resource for transmitting the uplink RS in response to the first indication signaling, so as to report the second latency variation explicitly to the base station based on the uplink resource indicated by the base station. Alternatively, the terminal may obtain the uplink resource pre-configured by the base station for the explicit reporting, so as to report the second latency variation explicitly to the base station based on the pre-configured uplink resource.

At step 502, the uplink resource for transmitting the uplink RS is determined according to the first indication signaling sent by the base station, and the second latency variation is reported explicitly to the base station via an uplink channel indicated by the uplink resource.

In the example of the present disclosure, after receiving the first indication signaling sent by the base station, the terminal may determine the uplink resource for transmitting the uplink RS according to the first indication signaling, and report the second latency variation of the service link explicitly to the base station on the uplink resource via the uplink channel. The uplink channel may be an uplink control channel or an uplink data channel.

According to the terminal positioning method provided in the example of the present disclosure, after calculating the second latency variation of the service link, the terminal may report the second latency variation to the base station in the explicit reporting scheme, so that the base station determines the actual round-trip latency from the base station to the terminal under the influence of satellite movement according to the first latency variation of the feeder link and the second latency variation of the service link, which achieves accurate positioning the terminal based on the round-trip latency and reduces the terminal positioning error caused by the rapid satellite movement.

FIG. 6 illustrates a schematic flowchart of a terminal positioning method according to an example of the present disclosure. The method, which is based on the examples illustrated in FIG. 3 and FIG. 4 and is illustrated in FIG. 6, is performed by a terminal and may include the following steps.

At step 601, a correspondence between uplink RS transmission information and second latency variations is determined.

The uplink RS transmission information includes one item of the following: time domain resources occupied by an uplink RS transmission; frequency domain resources occupied by the uplink RS transmission; or RS sequences for the uplink RS transmission.

In the example of the present disclosure, when the terminal reports the second latency variation implicitly to the base station, the latency-related variation information may be carried implicitly through information such as the time domain resource or frequency domain resource occupied for transmitting the uplink RS, or the RS sequence for transmitting the uplink RS, etc. Since the uplink RS transmission information of the same type may further include multiple categories, different category of uplink RS transmission information is selected correspondingly when the second latency variation is different. Therefore, in the example of the present disclosure, the correspondence between various pieces of uplink RS transmission information and second latency variations may be first determined, so as to quickly extract a piece of uplink RS transmission information matching the second latency variation according to the correspondence.

In an implementation, when determining the correspondence between uplink RS transmission information and second latency variations, the terminal may obtain it in advance from a protocol configuration, or determine the correspondence between uplink RS transmission information and second latency variations based on a high-level signaling or a physical layer signaling sent by the base station. Correspondingly, step 601 in the example may include: determining the correspondence between uplink RS transmission information and second latency variations from the protocol configuration. Alternatively, step 601 in the example may include: receiving a second indication signaling sent by the base station, where the second indication signaling indicates the correspondence between uplink RS transmission information and second latency variations, and the second indication signaling is the high-level signaling or the physical layer signaling. The high-layer signaling may include system information, an RRC signaling, or an MAC CE.

At step 602, the piece of uplink RS transmission information is determined according to the correspondence between uplink RS transmission information and second latency variations, and the second latency variation is report implicitly to the base station on the basis of the piece of uplink RS transmission information.

Taking an example that the RS sequence for transmitting the uplink RS is the uplink RS transmission information, it is supposed that the terminal determines, by being informed in advance or based on the high-layer signaling or the physical layer signaling sent by the base station, the correspondence between RS sequence values and second latency variations (such as timing advance (TA) variation) as shown in Table 1.

TABLE 1

| RS sequence value | TA variation |
|---|---|
| RS sequence 1 | TA variation 1 |
| RS sequence 2 | TA variation 2 |
| RS sequence 3 | TA variation 3 |

If the second latency variation (TA variation) of the service link of the terminal is calculated to be TA variation 2 in accordance with steps 301 to 303 in the example, it may be determined according to the correspondence between RS sequence values and TA variations shown in Table 1 that the matched uplink RS transmission information may be RS sequence 2, and then use RS sequence 2 to report the second latency variation of the service link implicitly to the base station.

Based on the same principle, the terminal may also determine, by being informed in advance or based on the high-layer signaling or the physical layer signaling sent by the base station, the correspondence between time or frequency domain resources for the RS transmission and the second latency variations, and carry the second latency variation of the service link implicitly by using the matched time domain resource or the matched frequency domain resource to transmit the uplink RS to the base station.

According to the terminal positioning method provided in the example of the present disclosure, after calculating the second latency variation of the service link, the terminal may report the second latency variation to the base station in the implicit reporting scheme, so that the base station determines the actual round-trip latency from the base station to the terminal under the influence of satellite movement according to the first latency variation of the feeder link and the second latency variation of the service link, which facilitates accurate positioning the terminal based on the round-trip latency and reduces the terminal positioning error caused by the rapid satellite movement.

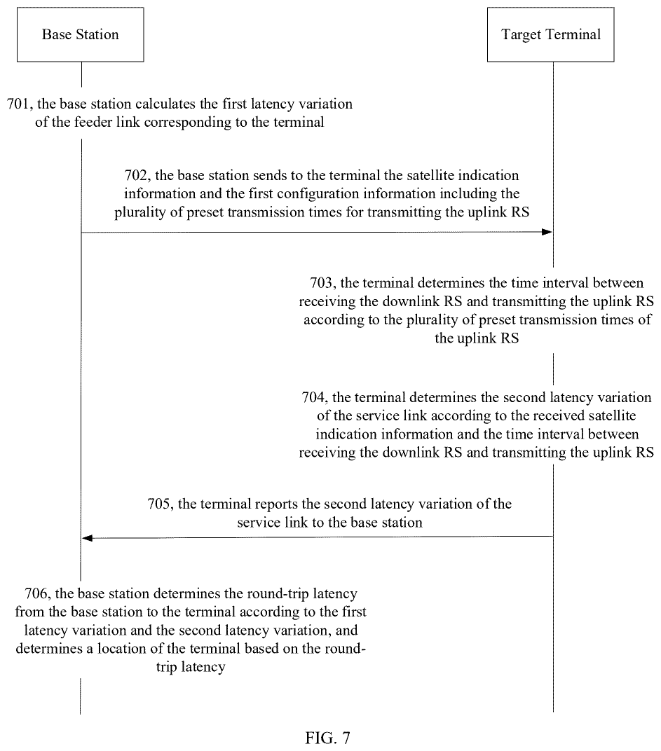

FIG. 7 is a time series diagram of a terminal positioning method according to an example of the present disclosure. The method is applied to a satellite communication system for positioning a terminal, which includes a base station and the terminal. The base station calculates a first latency variation of a feeder link corresponding to the terminal. The base station sends first configuration information and satellite indication information to the terminal, where the first configuration information includes a plurality of preset transmission times for transmitting an uplink RS. The terminal determines a time interval between receiving a downlink RS and transmitting the uplink RS according to the plurality of preset transmission times for the uplink RS, calculates a second latency variation of a service link according to the received satellite indication information and the time interval between receiving the downlink RS and transmitting the uplink RS, and reports the second latency variation of the service link to the base station. The base station determines a round-trip latency from the base station to the terminal according to the first latency variation and the second latency variation, and determines the location of the terminal based on the round-trip variation.

Referring to FIG. 7, the method includes the following steps.

At step 701, the base station calculates the first latency variation of the feeder link corresponding to the terminal.

In the example of the present disclosure, the base station may determine a transmission latency on the feeder link when transmitting the downlink RS to the terminal, and determine a reception latency on the feeder link when receiving the uplink RS transmitted by the terminal, determine a latency difference between the reception latency and the transmission latency, and determine the latency difference as the first latency variation of the feeder link corresponding to the terminal.

At step 702, the base station sends to the terminal the satellite indication information and the first configuration information including the plurality of preset transmission times for transmitting the uplink RS.

The satellite indication information includes second configuration information of a target satellite. The second configuration information includes information for determining a motion trajectory and a motion velocity of the target satellite.

At step 703, the terminal determines the time interval between receiving the downlink RS and transmitting the uplink RS according to the plurality of preset transmission times of the uplink RS.

In the example of the present disclosure, the terminal may obtain a predefined time interval between receiving the downlink RS and transmitting the uplink RS, and alternatively, the terminal may determine the signal transmission time of the uplink RS among the plurality of preset transmission times based on the signal reception time of the downlink RS, and calculate the time interval between receiving the downlink RS and transmitting the uplink RS according to the signal transmission time and the signal reception time. The plurality of preset transmission times are sent by the base station to the terminal.

At step 704, the terminal determines the second latency variation of the service link according to the received satellite indication information and the time interval between receiving the downlink RS and transmitting the uplink RS.

At step 705, the terminal reports the second latency variation of the service link to the base station.

In the example of the present disclosure, when reporting the second latency variation of the service link to the base station, two candidate schemes may be adopted, explicit reporting and implicit reporting.

Correspondingly, in the case where the terminal reports the second latency variation explicitly to the base station, the terminal may determine an uplink resource for transmitting the uplink RS in response to an indication from the base station, so as to report the second latency variation explicitly to the base station based on the uplink resource indicated by the base station, and alternatively, the terminal may obtain the uplink resource pre-configured by the base station for the explicit reporting, so as to report the second latency variation explicitly to the base station based on the pre-configured uplink resource. The specific implementation process may refer to the relevant descriptions of steps 501 to 502 in the example, which will not be repeated here.

Correspondingly, in the case where the terminal reports the second latency variation implicitly to the base station, the terminal may determine the correspondence between uplink RS transmission information and second latency variations, where the uplink RS transmission information includes any one item of: time domain resources occupied by an uplink RS transmission, frequency domain resources occupied by the uplink RS transmission, or RS sequences for the uplink RS transmission; determine a piece of matched uplink RS transmission information according to the correspondence between the uplink RS transmission information and second latency variations, and report the second latency variation of the service link implicitly to the base station on the basis of the piece of matched uplink RS transmission information. The specific implementation process may refer to the relevant descriptions of steps 601 to 602 in the example, which will not be repeated here.

At step 706, the base station determines the round-trip latency from the base station to the terminal according to the first latency variation and the second latency variation, and determines a location of the terminal based on the round-trip latency.

In the example of the present disclosure, a latency sum of the first latency variation and the second latency variation may be determined as a total latency variation caused by the satellite movement. Then, by adding the total latency variation to an overall latency calculated in a traditional way, the actual RTT from the base station to the terminal under the influence of satellite movement may be calculated. During determining the location of the terminal, the above steps may be repeated multiple times to calculate multiple (at least 3) final RTTs, and the terminal may be positioned on multiple circles with the base station as the centre and the c*RTTs (where c is the speed of light) as the radii. The intersection point of the multiple circles is the actual location of the terminal.

According to the terminal positioning method provided in the example of the present disclosure, when the satellite moves rapidly, it may use the base station to calculate the first latency variation on the feeder link, use the terminal to calculate the second latency variation on the service link, and finally use the base station to determine the actual round-trip latency from the base station to the terminal under the influence of satellite motion according to the first latency variation and the second latency variation. Therefore, it achieves accurately positioning the terminal based on the round-trip latency, and reduces the terminal positioning error caused by the rapid satellite movement.

In the foregoing examples provided in the present disclosure, the methods provided in the examples of the present disclosure are introduced from the perspectives of the base station and the terminal separately. In order to implement the various functions in the methods provided in the foregoing examples of the present disclosure, the base station and the terminal may include hardware structures and software modules, and implement the various functions in the form of the hardware structures, the software modules, or the hardware structures plus the software modules. A certain function among the various functions may be performed in the form of the hardware structures, the software modules, or the hardware structures plus the software modules.

Corresponding to the terminal positioning methods provided in the foregoing examples, the present disclosure also provides a terminal positioning apparatus. Since the terminal positioning apparatuses provided in the examples of the present disclosure correspond to the terminal positioning methods provided in the foregoing examples, the implementations of the terminal positioning methods are also applicable to the terminal positioning apparatuses provided in the examples and will not be described in detail in these examples.

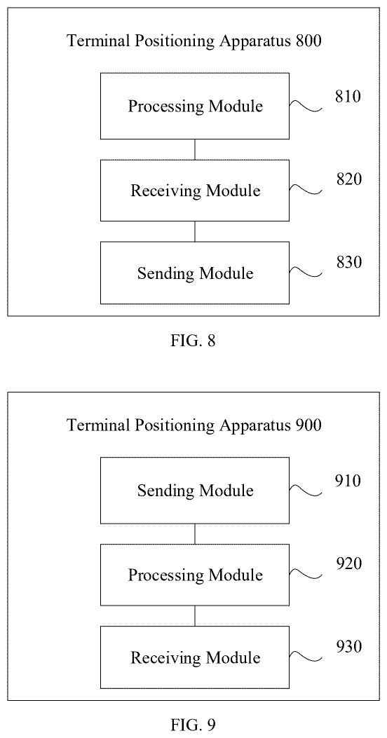

FIG. 8 is a schematic structural diagram of a terminal positioning apparatus 800 provided in an example of the present disclosure. The terminal positioning apparatus 800 may be a base station.

As illustrated in FIG. 8, the apparatus 800 may include:
a processing module 810 that is configured to determine a first latency variation of a feeder link corresponding to a terminal; and
a receiving module 820 that is configured to receive a second latency variation of a service link reported by the terminal.

The processing module 810 may be further configured to:
determine a round-trip latency from the apparatus 800 to the terminal according to the first latency variation and the second latency variation, and
determine a location of the terminal based on the round-trip latency.

In some examples of the present disclosure, the processing module 810 may be configured to:
determine a transmission latency on the feeder link upon transmitting a downlink RS to the terminal;
determine a reception latency on the feeder link upon receiving an uplink RS transmitted by the terminal;
determine a latency difference between the reception latency and the transmission latency; and
determine the latency difference as the first latency variation of the feeder link corresponding to the terminal.

In some examples of the present disclosure, the processing module 810 may be configured to determine a latency variation sum of the first latency variation and the second latency variation. The latency variation sum is configured for determining the round-trip latency from the apparatus 800 to the terminal.

In some examples of the present disclosure, as illustrated in FIG. 8, the apparatus further includes a sending module 830.

The sending module 830 may be configured to send first configuration information to the terminal. The first configuration information includes a plurality of preset transmission times for transmitting the uplink RS.

In some examples of the present disclosure, the sending module 830 may be configured to send satellite indication information to the terminal. The satellite indication information includes second configuration information of a target satellite, and the second configuration information includes information for determining a motion trajectory and a motion velocity of the target satellite.

In some examples of the present disclosure, the sending module 830 may be configured to send a first indication signaling to the terminal. The first indication signaling indicates an uplink resource for transmitting the uplink RS.

In some examples of the present disclosure, the sending module 830 may be configured to send a second indication signaling to the terminal. The second indication signaling indicates a correspondence between uplink RS transmission information and second latency variations. The second indication signaling is a high-layer signaling or a physical layer signaling.

The uplink RS transmission information include one item of:
time domain resources occupied by an uplink RS transmission;
frequency domain resources occupied by the uplink RS transmission; or
RS sequences for the uplink RS transmission.

FIG. 9 is a schematic structural diagram of a terminal positioning apparatus 900 provided in an example of the present disclosure. The terminal positioning apparatus 900 may be a terminal.

As illustrated in FIG. 9, the apparatus 900 may include:
a sending module 910 that is configured to report a second latency variation of a service link to a base station. The second latency variation is configured for determining a round-trip latency from the base station to the apparatus 900.

In some examples of the present disclosure, as illustrated in FIG. 9, the apparatus further includes a processing module 920 and a receiving module 930.

The processing module 920 may be configured to determine a time interval between receiving a downlink RS and transmitting an uplink RS.

The receiving module 930 is configured to receive satellite indication information sent by the base station. The satellite indication information includes second configuration information of a target satellite. The second configuration information includes information for determining a motion trajectory and a motion velocity of the target satellite

The processing module 920 may be further configured to determine the second latency variation according to the satellite indication information and the time interval between receiving the downlink RS and transmitting the uplink RS.

In some examples of the present disclosure, the processing module 920 may be configured to obtain a predefined time interval between receiving the downlink RS and transmitting the uplink RS. Alternatively, the processing module 920 may be configured to determine signal transmission time of the uplink RS among a plurality of preset transmission times based on a signal reception time of the downlink RS, and determine the time interval between receiving the downlink RS and transmitting the uplink RS according to the signal transmission time and the signal reception time

In some examples of the present disclosure, the receiving module 930 may be configured to receive first configuration information sent by the base station. The first configuration information includes the plurality of preset transmission times for transmitting the uplink RS.

In some examples of the present disclosure, the sending module 910 may be configured to determine an uplink resource for transmitting the uplink RS according to a first indication signaling sent by the base station, and report the second latency variation explicitly to the base station via an uplink channel indicated by the uplink resource. The uplink channel is an uplink control channel or an uplink data channel.

In some examples of the present disclosure, the receiving module 930 may be configured to receive the first indication signaling sent by the base station. The first indication signaling indicates the uplink resource for transmitting the uplink RS.

In some examples of the present disclosure, when reporting the second latency variation of the service link implicitly to the base station, the sending module 910 may be configured to determine a correspondence between uplink RS transmission information and second latency variations; determine a piece of uplink RS transmission information according to the correspondence between uplink RS transmission information and second latency variations; and report the second latency variation implicitly to the base station on the basis of the piece of uplink RS transmission information.

In some examples of the present disclosure, when determining the correspondence between uplink RS transmission information and second latency variations, the sending module 910 may be configured to determine the correspondence between uplink RS transmission information and second latency variations from a protocol configuration. Alternatively, the sending module 910 may be configured to receive a second indication signaling sent by the base station, where the second indication signaling indicates the correspondence between uplink RS transmission information and second latency variations, and the second indication signaling is a high-layer signaling or a physical layer signaling.

The uplink RS transmission information include one item of:
time domain resources occupied by an uplink RS transmission;
frequency domain resources occupied by the uplink RS transmission; or
RS sequences for the uplink RS transmission.

In some examples of the present disclosure, when reporting the second latency variation implicitly to the base station on the basis of the piece of uplink RS transmission information, the sending module 910 may be configured to report the second latency variation implicitly to the base station by using the piece of uplink RS transmission information to transmit the uplink RS to the base station.

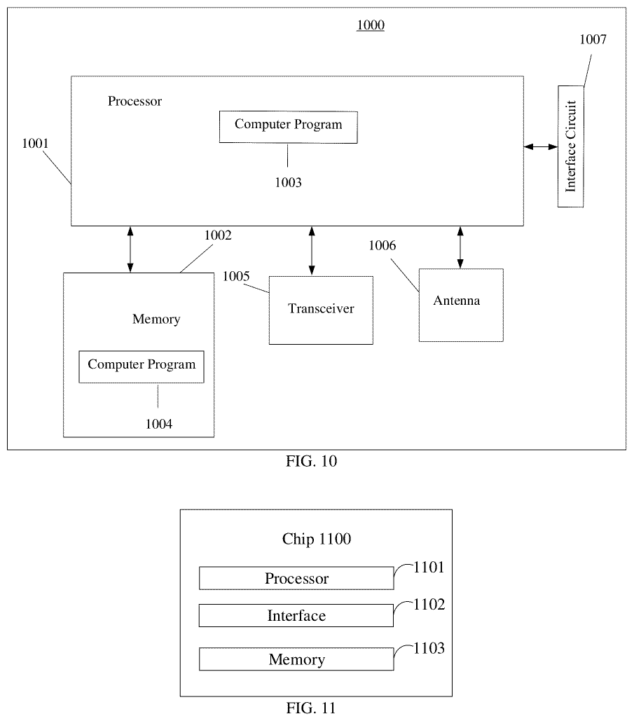

Referring to FIG. 10, it is a schematic structural diagram of a communication device 1000 provided in an example of the present disclosure. The communication device 1000 may be a network device, may be user equipment, may be a chip, a chip system or a processor that supports the network device to implement the foregoing methods, or may be a chip, a chip system or a processor that supports the user equipment to implement the foregoing methods. The apparatus may be configured to implement the methods described in the foregoing method examples, whose details may refer to the descriptions of the foregoing method examples.

The communications device 1000 may include one or more processors 1001. The processor 1001 may be a general processor, a dedicated processor or the like. For example, it may be a baseband processor or a central processor. The baseband processor may be configured to process communication protocols and communication data, and the central processor may be configured to control the communication device (such as a base station, a baseband chip, a terminal device, a terminal device chip, a distributed unit (DU) or a centralized unit (CU), etc.) to execute a computer program and process data of the computer program.

Alternatively, or additionally, the communication device 1000 may further include one or more memories 1002, on which a computer program 1004 may be stored, and the one or more processors 1001 execute the computer program 1004, so as to enable the communication device 1000 to perform the methods described in the foregoing method examples. Alternatively, or additionally, the one or more memories 1002 may further store data. The communication device 1000 and the one or more memories 1002 may be set separately or integrated together.

Alternatively, or additionally, the communication device 1000 may further include one or more transceivers 1005 and one or more antennas 1006. The transceiver 1005 may be referred to as a transceiving unit, a transceiving machine, or a transceiving circuit, etc., and is configured to implement a transmission and reception function. The transceiver 1005 may include a receiver and a transmitter. The receiver may be called a receiving machine or a receiving circuit for implementing a reception function, and the transmitter may be called a transmitting machine or a transmitting circuit for implementing a transmission function.

Alternatively, or additionally, the communication device 1000 may further include one or more interface circuits 1007. The one or more interface circuits 1007 are configured to receive and transmit code instructions to the one or more processors 1001. The one or more processors 1001 execute the code instructions to enable the communication device 1000 to perform the methods described in the foregoing method examples.

In an implementation, the one or more processors 1001 may include the one or more transceivers for implementing the transmission and reception function. For example, the transceiver may be a transceiving circuit, or an interface, or an interface circuit. The transceiving circuit, interface or interface circuit for implementing the transmission and reception function may be separated or integrated together. The transceiver circuit, interface or interface circuit may be configured to read and write code/data. Alternatively, the transceiver circuit, interface or interface circuit may be configured to transmit or transfer signals.

In an implementation, the one or more processors 1001 may store a computer program 1003, and the computer program 1003 runs on the one or more processors 1001 to enable the communication device 1000 to perform the methods described in the foregoing method examples. The computer program 1003 may be solidified in the one or more processors 1001. In this case, the one or more processors 1001 may be implemented by hardware.

In an implementation, the communication device 1000 may include a circuit, and the circuit may implement the function of transmitting, receiving or communicating in the foregoing method examples. The one or more processors and transceivers described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The one or more processors and transceivers may also be fabricated with various IC processing technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above examples may be the network device or the user equipment. However, the communication device described in the present disclosure is not limited by such a range, and the structure of the communication device may not be limited to FIG. 10. The communication device may be a stand-alone device or may be a part of a larger device. For example, the communication device may be:
(1) stand-alone ICs, chips, or chip systems or subsystems;
(2) a set of one or more ICs, which may alternatively or additionally include one or more storage components for storing data and computer programs;
(3) ASIC, such as a modem;
(4) modules that may be embedded in other devices;
(5) a receiver, a terminal device, an intelligent terminal device, a cellular phone, a wireless device, a handset, a mobile unit, a vehicle-mounted device, a network device, a cloud device, an artificial intelligence device, etc.;
(6) others and so on.

For the case where the communications device may be a chip or a chip system, it may refer to the schematic structural diagram of the chip 1100 illustrated in FIG. 11. The chip 1100 illustrated in FIG. 11 includes one or more processors 1101 and one or more interfaces 1102. The number of the one or more processors 1101 may be one or more than one, and the number of the one or more interfaces 1102 may be more than one.

Alternatively, or additionally, the chip 1100 also includes one or more memories 1103 for storing necessary computer programs and data.

Those skilled in the art may also understand that various illustrative logical blocks and steps presented in the examples of the present disclosure may be implemented through electronic hardware, computer software, or a combination of the both. Whether such functions are implemented through the hardware or the software depends on specific applications and overall system design requirements. Those skilled in the art may use various approaches to implement the described function for each specific application. However, such implementation should not be understood as exceeding the protection scope of the examples of the present disclosure.

The present disclosure also provides a readable storage medium on which instructions are stored. The instructions, when executed by a computer, implement the functions of any one of the foregoing method examples.

The present disclosure also provides a computer program product, which implements the functions of any one of the foregoing method examples when being executed by a computer.

In the above examples, it can be implemented in whole or in part by software, hardware, firmware, or any combination thereof. When implemented in software, it may be implemented in whole or in part in the form of a computer program product. The computer program product includes one or more computer programs. When the computer programs are loaded and executed on a computer, the processes or functions according to the examples of the present disclosure are generated in whole or in part. The computer may be a general-purpose computer, a dedicated computer, a computer network, or another programmable device. The computer programs may be stored in a computer-readable storage medium or transmitted from one computer-readable storage medium to another computer-readable storage medium, for example, the computer programs may be transmitted from a website site, a computer, a server or a data center via wire (for example, coaxial cable, optical fiber, digital subscriber line (DSL)) or wireless (for example, infrared, wireless, microwave, etc.) to another website site, another computer, another server, or another data center. The computer-readable storage medium may be any available medium that can be accessed by a computer or a data storage device such as a server and a data center integrating one or more available media. The available medium may be a magnetic medium (for example, a floppy disk, a hard disk, a magnetic tape), an optical medium (for example, a high-density digital video disc (DVD)), or a semiconductor medium (for example, a solid state disk (SSD)), etc.

Those of ordinary skill in the art may understand that the division of first, second, and other numbers involved in the present disclosure are only for convenience of description, instead of limiting the scope of the examples of the present disclosure or indicating a sequential order.

“At least one” in the present disclosure may also be described as “one or more”. The “more” may refer to two, three, four or more, which is not limited in the present disclosure. In the examples of the present disclosure, for a technical character, its technical features are distinguished by “first,” “second,” “third,” “A,” “B,” “C,” and “D,” etc. There is no sequential order or size order between the technical features described by the “first,” “second,” “third,” “A,” “B,” “C,” and “D.”

As used herein, the terms “machine-readable medium” and “computer-readable medium” refer to any computer program product, device, and/or apparatus for providing machine instructions and/or data to a programmable processor (e.g., a magnetic disk, an optical disk, memory, a programmable logic device (PLD)), including a machine-readable medium that receives machine instructions as machine-readable signals. The term “machine-readable signal” refers to any signal for providing machine instructions and/or data to the programmable processor.

The systems and techniques described herein may be implemented in a computing system including a back-end component (e.g., as a data server), in a computing system including a middleware component (e.g., an application server), in a computing system including a front-end component (e.g., a user computer having a graphical user interface or a web browser through which a user can interact with implementations of the systems and techniques described herein), or in a computing system including any combination of such back-end component, such middleware component or such front-end component. The components of the system may be interconnected in any form or medium of digital data communication (e.g., a communication network). Examples of the communication network include a local area network (LAN), a wide area network (WAN), and Internet.

The computing system may include a client and a server. The client and the server are generally remote from each other and typically interact through the communication network. The relationship between the client and the server is established by computer programs running on the respective computers and having a client-server relationship with each other.

It is to be understood that the processes illustrated above may be used in various forms, with one or more steps being reordered, added or deleted. For example, the steps described in the present disclosure may be performed in parallel, in sequence, or in a different order, which is not limited herein as long as the expected results of the technical solutions disclosed in the present disclosure can be achieved.

In addition, it is to be understood that the various examples of the present disclosure may be implemented individually or in combination with other examples when the solution permits.

Those skilled in the art may appreciate that the units and algorithm steps of each illustration described in conjunction with the examples disclosed herein may be implemented by electronic hardware, computer software, or a combination of computer software and electronic hardware. Whether these functions are performed by hardware or by software depends on the specific application and the design constraint conditions of the technical solution. Those skilled in the art may adopt a different method for each specific application to implement the described functions, which, however, should not be considered as being beyond the scope of the present disclosure.

Those skilled in the art may clearly understand that, for the convenience and brevity of description, the specific working processes of the systems, apparatuses, and units described above may refer to the corresponding processes in the foregoing method examples and will not be repeated here.

The foregoing description is merely specific implementations of the present disclosure, but the protection scope of the present disclosure is not limited thereto, and their variations or replacements within the technical scope disclosed in the present disclosure, which is readily conceivable by any person skilled in the art, should be covered within the protection scope of the present disclosure. Therefore, the protection scope of the present disclosure should be based on the protection scope of the claims.

1. A terminal positioning method, performed by a base station, comprising:
determining a first latency variation of a feeder link corresponding to a terminal;
receiving a second latency variation of a service link reported by the terminal;
determining a round-trip latency from the base station to the terminal according to the first latency variation and the second latency variation, and
determining a location of the terminal based on the round-trip latency.

2. The method according to claim 1, wherein determining the first latency variation of the feeder link corresponding to the terminal comprises:
determining a transmission latency on the feeder link upon transmitting a downlink reference signal (RS) to the terminal;
determining a reception latency on the feeder link upon receiving an uplink RS transmitted by the terminal;
determining a latency difference between the reception latency and the transmission latency; and
determining the latency difference as the first latency variation of the feeder link corresponding to the terminal.

3. The method according to claim 1, further comprising:
determining a latency variation sum of the first latency variation and the second latency variation, wherein the latency variation sum is configured for determining the round-trip latency from the base station to the terminal.

4. The method according to claim 1, further comprising:
sending first configuration information to the terminal, wherein the first configuration information comprises a plurality of preset transmission times for transmitting an uplink reference signal (RS).

5. The method according to claim 1, further comprising:
sending satellite indication information to the terminal,
wherein the satellite indication information comprises second configuration information of a target satellite, and
wherein the second configuration information comprises information for determining a motion trajectory and a motion velocity of the target satellite.

6. The method according to claim 1, further comprising:
sending a first indication signaling to the terminal, wherein the first indication signaling indicates an uplink resource for transmitting an uplink reference signal (RS).

7. The method according to claim 1, further comprising:
sending a second indication signaling to the terminal,
wherein the second indication signaling indicates a correspondence between uplink reference signal (RS) transmission information and second latency variations,
wherein the second indication signaling is a high-layer signaling or a physical layer signaling; and
wherein the uplink RS transmission information comprises one item of:
time domain resources occupied by an uplink RS transmission;
frequency domain resources occupied by the uplink RS transmission; or
RS sequences for the uplink RS transmission.

8. A terminal positioning method, performed by a terminal, comprising:
reporting a latency variation of a service link to a base station, wherein the latency variation is configured for determining a round-trip latency from the base station to the terminal.

9. The method according to claim 8, further comprising:
determining a time interval between receiving a downlink reference signal (RS) and transmitting an uplink RS;
receiving satellite indication information sent by the base station, wherein the satellite indication information comprises second configuration information of a target satellite, and wherein the second configuration information comprises information for determining a motion trajectory and a motion velocity of the target satellite; and
determining the latency variation according to the satellite indication information and the time interval between receiving the downlink RS and transmitting the uplink RS.

10. The method according to claim 9, wherein determining the time interval between receiving the downlink RS and transmitting the uplink RS comprises:
obtaining a predefined time interval between receiving the downlink RS and transmitting the uplink RS; or,
determining signal transmission time of the uplink RS among a plurality of preset transmission times based on a signal reception time of the downlink RS, and determining the time interval between receiving the downlink RS and transmitting the uplink RS according to the signal transmission time and the signal reception time.

11. The method according to claim 10, further comprising:
receiving first configuration information sent by the base station, wherein the first configuration information comprises the plurality of preset transmission times for transmitting the uplink RS.

12. The method according to claim 8, wherein reporting the latency variation of the service link to the base station comprises:
determining an uplink resource for transmitting an uplink reference signal (RS) according to a first indication signaling sent by the base station; and
reporting the latency variation explicitly to the base station via an uplink channel indicated by the uplink resource, wherein the uplink channel is an uplink control channel or an uplink data channel.

13. The method according to claim 12, further comprising:
receiving the first indication signaling sent by the base station, wherein the first indication signaling indicates the uplink resource for transmitting the uplink RS.

14. The method according to claim 8, wherein reporting the latency variation of the service link to the base station comprises:
determining a correspondence between uplink reference signal (RS) transmission information and second latency variations;
determining a piece of uplink RS transmission information according to the correspondence between uplink RS transmission information and latency variations; and
reporting the latency variation implicitly to the base station on a basis of the piece of uplink RS transmission information.

15. The method according to claim 14, wherein determining the correspondence between uplink RS transmission information and latency variations comprises:
determining the correspondence between uplink RS transmission information and latency variations from a protocol configuration; or
receiving a second indication signaling sent by the base station, wherein the second indication signaling indicates the correspondence between uplink RS transmission information and latency variations, and wherein the second indication signaling is a high-layer signaling or a physical layer signaling;
wherein the uplink RS transmission information comprises one item of:
time domain resources occupied by an uplink RS transmission;
frequency domain resources occupied by the uplink RS transmission; or
RS sequences for the uplink RS transmission.

16. The method according to claim 14, wherein reporting the latency variation implicitly to the base station on the basis of the piece of uplink RS transmission information comprises:
reporting the latency variation implicitly to the base station by using the piece of uplink RS transmission information to transmit the uplink RS to the base station.

17. (canceled)

18. (canceled)

19. A communication device, comprising:
one or more transceivers;
one or more memories; and
one or more processors connected to the one or more transceivers and the one or more memories separately,
wherein the one or more processors are configured to:
determine a first latency variation of a feeder link corresponding to a terminal;
receive a second latency variation of a service link reported by the terminal:
determine a round-trip latency from the communication device to the terminal according to the first latency variation and the second latency variation; and
determine a location of the terminal based on the round-trip latency.

20. A non-transitory computer storage medium storing computer-executable instructions that, when executed by one or more processors, cause the one or more processors to perform the method according to claim 1.

21. (canceled)

22. A communication device, comprising:
one or more transceivers;
one or more memories; and
one or more processors connected to the one or more transceivers and the one or more memories separately,
wherein the one or more processors are configured to perform the method according to claim 8.

23. A non-transitory computer storage medium storing computer-executable instructions that, when executed by one or more processors, cause the one or more processors to perform the method according to claim 8.
